(19) United States
(12) Patent Application Publication
(10) Pub. No.: US 2013/0076696 A1
(43) Pub. Date: Mar. 28, 2013

(54) DISPLAY APPARATUS

(71) Applicant: Jinsoo SHIN, Asan-si (KR)

(72) Inventor: Jinsoo SHIN, Asan-si (KR)

(21) Appl. No.: 13/585,236

(22) Filed: Aug. 14, 2012

(30) Foreign Application Priority Data
Sep. 28, 2011 (KR) 10-2011-0098493

(51) Int. Cl. G06F 3/042

(52) U.S. Cl. 345/175

(57) ABSTRACT

A display apparatus includes a display panel including a front surface on which an image is displayed, a top chassis covering an edge portion of the display panel, and a light sensor disposed on the top chassis to sense a touch event occurring on the front surface.

### CROSS-REFERENCE TO RELATED APPLICATION

This application claims priority to Korean Patent Application No. 10-2011-0098493 filed on Sep. 28, 2011, the contents of which are herein incorporated by reference in its entirety.

### TECHNICAL FIELD

The embodiments of the present invention relate to a display apparatus. More particularly, the embodiments of the present invention relate to a display apparatus that can sense touches.

### DISCUSSION OF THE RELATED ART

In general, a display apparatus includes a display panel for displaying image information, a driver for driving the display panel, and a receiving member for receiving the display panel and the driver. The display apparatus converts signal information from electric appliances into images.

The display apparatus may have various sizes according to the electric appliances in which the display apparatus is used.

### SUMMARY

Exemplary embodiments of the present invention provide a display apparatus that can sense touches.

According to an exemplary embodiment, a display apparatus includes a display panel including a front surface on which an image is displayed, a top chassis covering an edge portion of the display panel, and at least two light sensors on the top chassis at at least two corners, respectively, of the display panel. The light sensors sense a touch on the front surface.

The light sensors are disposed at two ends of a side of the display panel, and each of the light sensors includes a light emitting part and a light receiving part. The display apparatus may further include a reflection part on an inner surface of the top chassis which corresponds to another side of the display panel. The reflection part reflects light emitted from the light emitting part.

The display apparatus further includes a light sensing controller, which is mounted on a circuit board and controls the light sensors, and a display driver connected to the display panel and mounted on another circuit board. The display driver drives the display panel. The light sensing controller and the display driver are disposed on a rear surface of the display panel, and the light sensing controller and the display driver partially overlap each other.

The front surface of the display panel includes a display area displaying the image and a peripheral area surrounding the display area, the top chassis includes a front portion covering the peripheral area along the edge portion of the display panel and a side portion bending and extending downward from the front portion and covering a side of the display panel, and the light sensors are disposed between the front surface and the front portion. The top chassis further includes a protrusion portion protruding downward from the front portion and facing the light sensors. The reflection part is disposed on the protrusion portion.

A thickness of the display apparatus may be reduced. The display apparatus may not include an assembly for accommodating the light sensors and the reflection part, and the light sensor and the reflection part may be directly coupled with the top chassis, thereby reducing thickness and cost of the display apparatus.

### BRIEF DESCRIPTION OF THE DRAWINGS

The embodiments of the present invention will become readily apparent by reference to the following detailed description when considered in conjunction with the accompanying drawings wherein:

FIG. 1 is an exploded perspective view showing a display apparatus according to an exemplary embodiment of the present invention;

FIG. 2 is a cross-sectional view taken along a line I-I′ shown in FIG. 1;

FIG. 3 is a cross-sectional view taken along a line II-II′ shown in FIG. 1 to show a top chassis according to an exemplary embodiment of the present invention;

FIG. 4 is a plan view showing the light sensing part;

FIG. 5 is a perspective view showing a top chassis according to an exemplary embodiment of the present invention;

FIG. 6 is a cross-sectional view taken along a line shown in FIG. 5 to show a top chassis according to an exemplary embodiment of the present invention; and

FIG. 7 is a cross-sectional view showing a top chassis of a display apparatus according to an exemplary embodiment of the present invention.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. Like numbers may refer to like and similar elements throughout the drawings and the specification. As used herein, the term “and/or” includes any and all combinations of one or more of the associated listed items.

As used herein, the singular forms, “a”, “an” and “the” are intended to include the plural forms as well, unless the context clearly indicates otherwise.

Hereinafter, the embodiments of the present invention will be described in detail with reference to the accompanying drawings. However, the present invention may be embodied in various different ways and should not be construed as limited to the exemplary embodiments described herein.

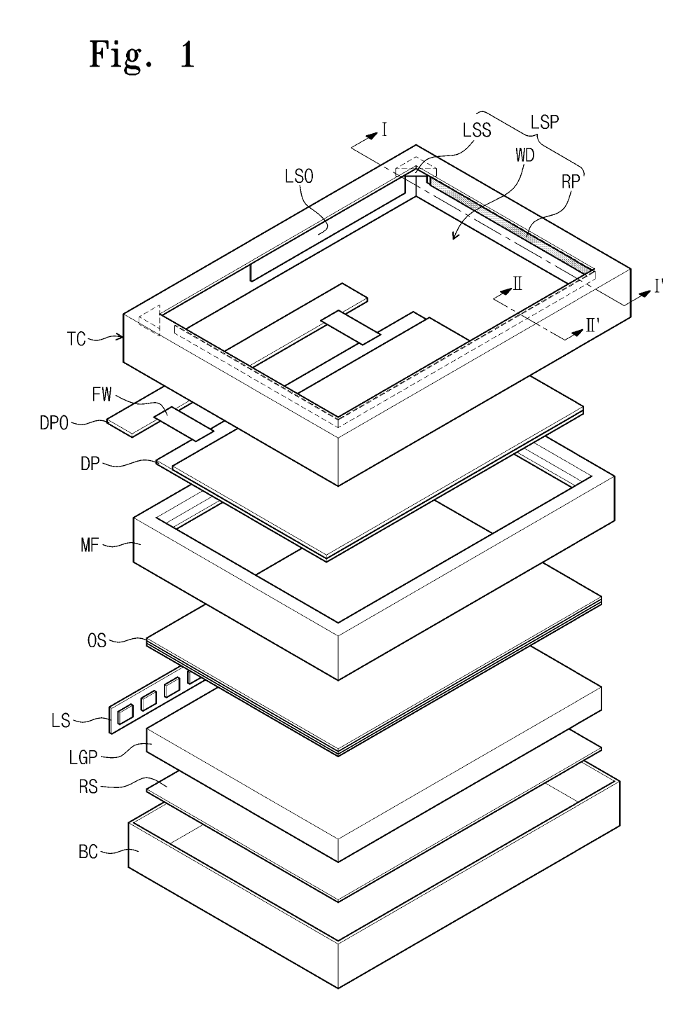

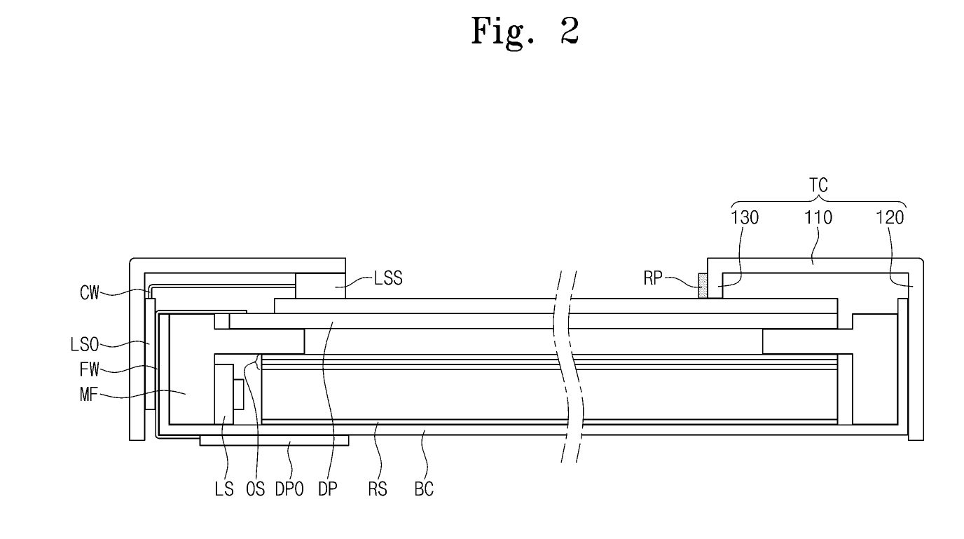

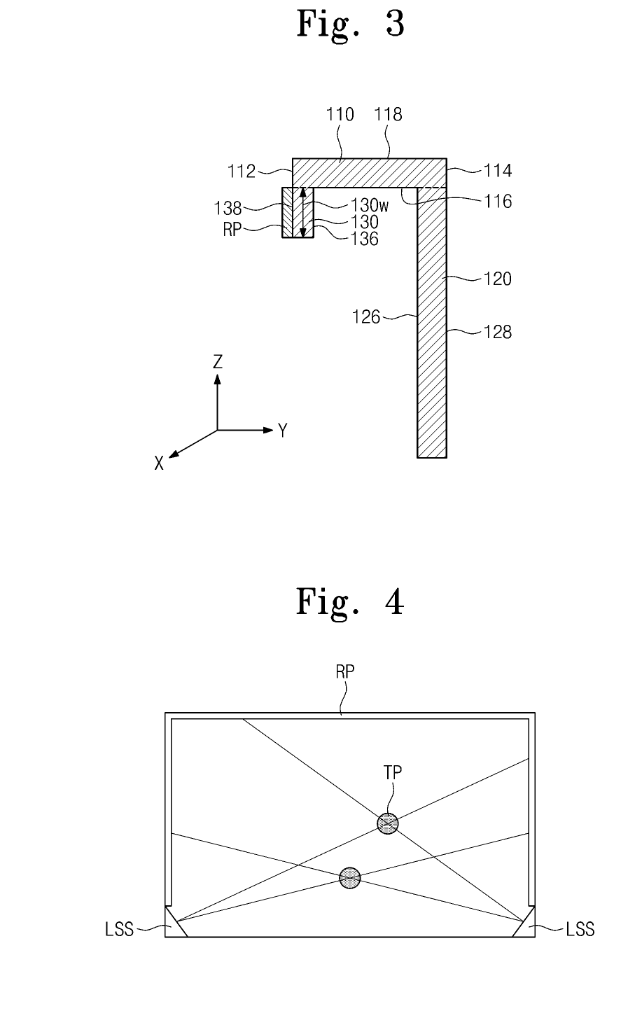

FIG. 1 is an exploded perspective view showing a display apparatus according to an exemplary embodiment of the present invention, and FIG. 2 is a cross-sectional view taken along a line I-I′ shown in FIG. 1. FIG. 3 is a cross-sectional view taken along a line II-II′ shown in FIG. 1 to show a top chassis according to an exemplary embodiment of the present invention.

Referring to FIGS. 1, 2 and 3, the display apparatus includes a display panel DP, a mold frame MF, a backlight assembly, a bottom chassis BC, a top chassis TC, and a light sensing part LSP.

The display panel DP displays an image. According to an embodiment, the display panel DP is not a self-emissive display panel, and the display panel DP is one of various display panels, such as a liquid crystal display panel, an electrophoretic display panel, etc. According to an exemplary embodiment, as an example, the liquid crystal display panel is described as the display panel DP.

The display panel DP has a rectangular plate shape with a long side and a short side. The display panel DP includes a front surface on which an image is displayed and a rear surface opposite to the front surface. The display panel DP includes a display area in which an image is displayed and a peripheral area surrounding the display area. The display panel DP includes a plurality of pixels that are arranged in the display area and display an image. The display panel DP includes a display driver DPO to control the pixels. The display driver DPO is connected to the display panel DP through at least one flexible wire FW, e.g., a flexible printed circuit board or a tape carrier package. The display driver DPO is mounted on a circuit board. For convenience of description, the circuit board and the display driver are jointly represented as the display driver DPO in FIGS. 1 and 2.

The mold frame MF is provided along an edge portion of the display panel DP under the display panel DP and supports the display panel DP. The mold frame MF has a rectangular ring shape. A single mold frame MF is provided as shown in FIGS. 1 and 2, but the embodiments of the present invention are not limited thereto. For example, according to an embodiment, a plurality of mold frames MF are provided.

The backlight assembly is disposed under the display panel DP and provides light to the display panel DP. The backlight assembly includes a light source LS emitting light, a light guide plate LGP guiding light to the display panel DP from the light source LS, an optical sheet OS improving light utilization efficiency, and a reflection sheet RS changing a direction in which light travels.

The light source LS provides light to the light guide plate LGP. The light guide plate LGP has a rectangular plate shape and is disposed under the display panel DP. Among surfaces defining the shape of the light guide plate LGP, two wider surfaces facing each other are disposed substantially parallel to the display panel DP. The light guide plate LGP guides light to the display panel DP.

The optical sheet OS is disposed between the light guide plate LGP and the display panel DP. The optical sheet OS controls light emitted from the light sources LS. The optical sheet OS includes a diffusion sheet, a prism sheet, and a protection sheet, which are sequentially stacked on the light guide plate LGP. The diffusion sheet diffuses light, and the prism sheet condenses light diffused by the diffusion sheet to be directed in a direction substantially perpendicular to the display panel DP. Light exiting from the prism sheet is vertically incident into the display panel DP. The protection sheet is disposed on the prism sheet. The protection sheet protects the prism sheet from external impacts. Although the optical sheet OS includes one diffusion sheet, one prism sheet, and one protection sheet, the embodiments of the present invention are not limited thereto. According to an embodiment, a plurality of diffusion sheets, a plurality of prism sheets, or a plurality of protection sheets are provided, or according to an embodiment, one of the diffusion sheet, the prism sheet, and the protection sheet is omitted from the optical sheet OS.

The reflection sheet RS is disposed under the light guide plate LGP and over the bottom chassis BC and reflects light. In detail, the reflection sheet RS reflects light, which leaks from the light guide plate LGP without being directed to the display panel DP, back to the display panel DP. The reflection sheet RS includes a material that reflects light. As a result, the amount of light directed to the display panel DP is increased by the reflection sheet RS.

The top chassis TC is disposed on the display panel DP. The top chassis TC covers an edge portion of the front surface of the display panel DP and has a rectangular ring shape corresponding to the edge portion of the display panel DP. The top chassis TC includes a display window WD which is formed by removing a center portion of the top chassis TC and exposes the display area of the display panel DP. The top chassis TC includes a front portion 110 that covers the peripheral area along the edge portion of the display panel DP, a side portion 120 that bends and extends downward from the front portion 110 and covers a side of the display panel DP, and a protrusion portion 130 that protrudes downward from the front portion 110. The protrusion portion 130 bends and extends from the front portion 110 or protrudes from a rear surface of the front portion 110.

The light sensing part LSP senses a touch that occurs on the front surface of the display panel DP. The light sensing part LSP includes at least two light sensors LSS and a light sensing controller LSO.

The light sensors LSS are disposed between the front surface of the display panel DP and the front portion 110 of the top chassis TC and respectively correspond to two corners of the display panel DP. The light sensors LSS are attached to the top chassis TC using an adhesive. Each of the light sensors LSS includes a light emitting part and a light receiving part, or includes only the light receiving part. In the case that the light sensors LSS include only the light receiving part, the light emitting part is added to the light sensing part LSP separately. For purposes of illustration, each light sensor LSS including the light emitting part and the light receiving part is described as an example. According to an exemplary embodiment, light emitted from or detected by the light sensors LSS is an infrared ray.

The light sensing part LSP further includes a reflection part RP that reflects light emitted from the light emitting part to the light receiving part. When two light sensors LSS are provided, the light sensors LSS are provided at two ends of one side of the display panel DP. The reflection part RP is provided on the top chassis TC corresponding to the other sides of the display panel DP except for the one side. The reflection part RP has a tape shape and is attached on the protrusion part 130.

The light sensing controller LSO is connected to the light sensors LSS by a connection wire CW and controls the light sensors LSS. The light sensing controller LSO obtains information on the position of a touch by applying a triangular measuring method to data provided from the light sensors LSS. FIG. 4 is a plan view showing the light sensing part LSP. A light emitted from the emitting part of the light sensors at two ends of one side of the display panel DP is reflected by the reflection part RP, thereby the light goes back in direction to the light sensors LSS. The light sensors receive the light which is reflected. If a touch event is happen by a user, a light from the emitting part of the light sensors is blocked in a touch point TP, thereby the light cannot be reflected and consequently cannot arrive at the light sensors LSS. The light sensors LSS obtain the information, i.e., whether the touch event happens and where its position is, by detecting the difference the light intensity. The light sensing controller LSO is mounted on a circuit board, and for convenience of description, the circuit board and the light sensing controller LSO are jointly represented as the light sensing controller LSO as shown in FIGS. 1 and 2.

The bottom chassis BC is disposed under the backlight assembly and accommodates the backlight assembly. The bottom chassis BC includes a bottom portion substantially parallel to the rear surface of the reflection sheet RS and a side portion bent and extended upward from the bottom portion. The backlight assembly is accommodated in a space defined by the bottom portion and the side portion of the bottom chassis BC.

According to an exemplary embodiment, the flexible wire FW that connects the display panel DP with the display driver DPO is bent along an outer portion of the mold frame MF. Accordingly, the display driver DPO is disposed under the bottom chassis BC. The light sensing controller LSO is adjacent to a side of the mold frame MF and perpendicular to the front surface of the display panel DP.

In the display apparatus, light is emitted from the light sensors LSS to the reflection part RP, and the reflection part RP reflects light. The light sensors LSS receive light reflected by the reflection part RP. When a touch occurs on the front surface of the display panel DP, light emitted from the light sensors LSS and reflected by the reflection part RP is blocked at a position of the touch. As a result, the amount of light received by the light sensors LSS changes so that the touch can be confirmed. According to an exemplary embodiment, the touch position is confirmed by the light sensors LSS using a triangular measuring method.

Referring to FIG. 3, a top chassis of a display apparatus according to an exemplary embodiment of the present invention will be explained. According to an exemplary embodiment, a front portion, a side portion, and a protrusion portion of the top chassis are referred to as a first part, a second part, and a third part, respectively.

Referring to FIG. 3, the top chassis may include the first part 110, the second part 120 connected to the first part 110, and the third part 130 extended from the first part 110. The top chassis TC includes a metal or non-metal material.

The first part 110 has a rectangular frame shape with an opening area when viewed in a plan view. The first part 110 includes an inner surface 112, an outer surface 114 opposite to the inner surface 112, a first outer surface 118 connecting the inner surface 112 with the outer surface 114, and a first inner surface 116 opposite to the first outer surface 118. The first inner surface 116 and the first outer surface 118 are substantially parallel to each other. When the top chassis TC is disposed so that the first outer surface 118 is directed in an upper direction of the first outer surface 118, the first inner surface 116 faces the display panel. The first part 110 has a first width 110w. The first width 110w is a distance of a straight line between the inner surface 112 and the outer surface 114, which is perpendicular to the inner surface 112 and the outer surface 114.

The second part 120 is connected to the outer surface 114 and perpendicular to the first part 110. For instance, when the first part 110 is disposed such that the first inner surface 116 is substantially parallel to a surface defined by an x-axis and a y-axis, the second part 120 has a second width 120w in a z-axis. The second part 120 protrudes and extends from the first inner surface 116. The second part 120 has the second width 120w and is elongated along a z-axis direction. The second part 120 includes a second inner surface 126 and a second outer surface 128, which are substantially parallel to each other and opposite to each other. The second inner surface 126 extends from the first inner surface 116, and the second outer surface 128 extends from the outer surface 114. An angle between the second inner surface 126 and the first inner surface 116 is a right angle, an acute angle, or an obtuse angle.

The third part 130 is disposed adjacent to the inner surface 112 and spaced apart from the second part 120 and extends from the first part 110. The third part 130 is connected to the inner surface 112 and perpendicular to the first part 110. For example, the third part 130 faces the second part 120. For instance, the third part 130 is substantially parallel to the second part 120. The third part 130 has a third width 130w and is elongated along the z-axis direction. According to an embodiment, the third part 130 is discontinuously arranged at a specific area. For instance, the third part 130 is discontinuously arranged at an area where the light sensors are disposed. The third part 130 includes a third inner surface 136 and a third outer surface 138, which are substantially parallel to each other and opposite to each other. The third inner surface 136 faces the second inner surface 126. The third inner surface 136 is connected to the first inner surface 116. The third outer surface 138 is connected to the first outer surface 118 through the inner surface 112. The third outer surface 138 is oriented toward the opening area of the first part 110. According to an embodiment, an angle between the third inner surface 136 and the first inner surface 116 is a right angle, an acute angle, or an obtuse angle.

The first part 110 is connected to the second part 120 and the third part 130 in the z-axis direction. According to an exemplary embodiment, the first width 110w and the second width 120w are wider than the third width 130w.

In the top chassis TC, the first part 110 is integrally formed with the third part 130, or the first part 110, the second part 120, and the third part 130 are integrally formed with each other. According to an embodiment, the top chassis TC is formed by coupling the first part 110, the second part 120, and the third part 130, which are separated from each other. The top chassis TC is formed by an injection molding method. According to an embodiment, the third part 130 is formed by bending the first part 110 several times.

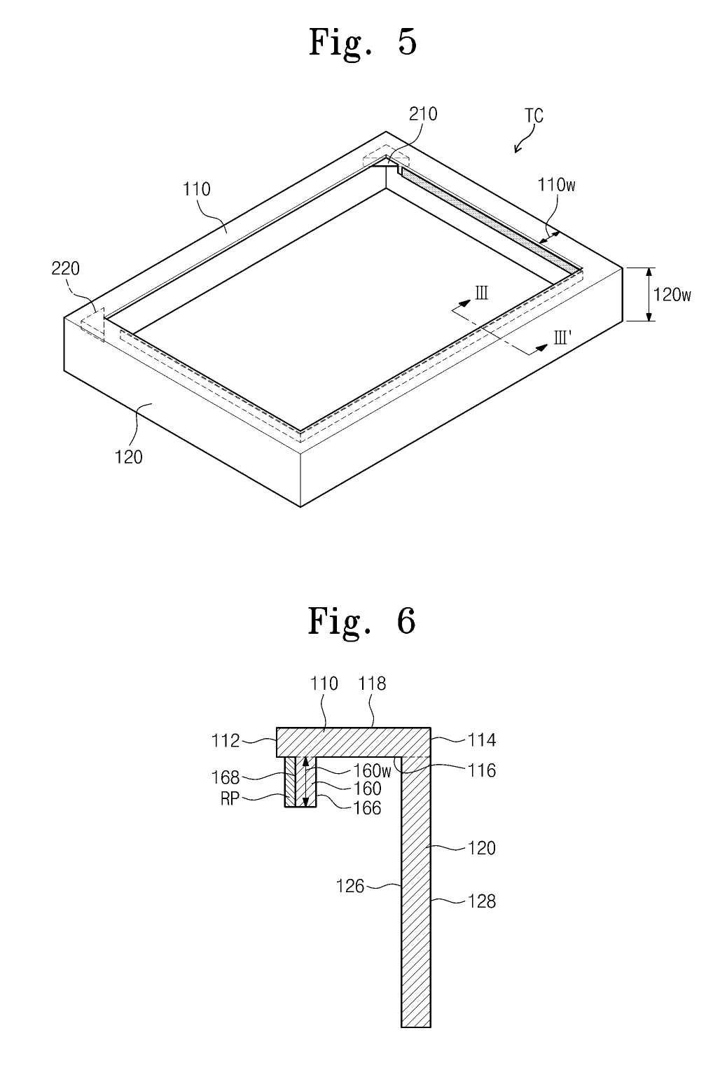

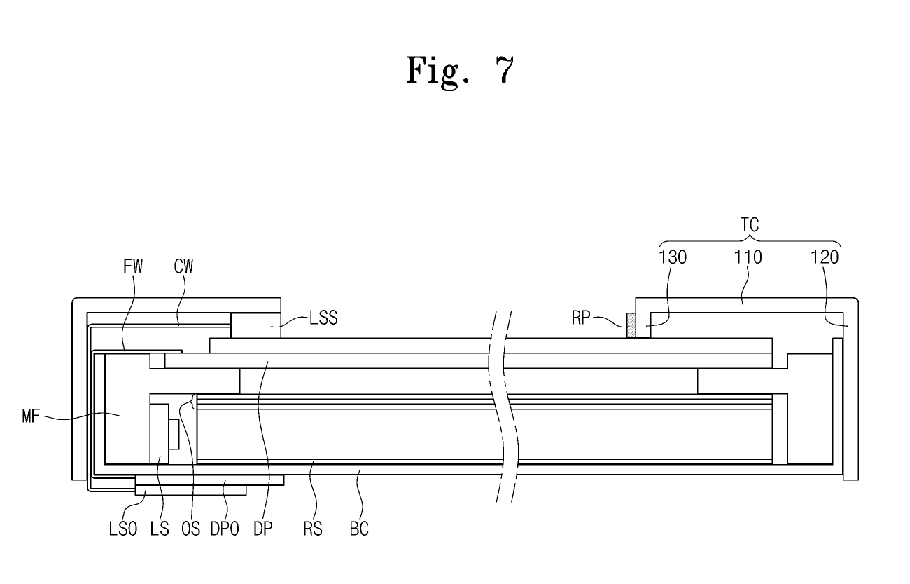

FIG. 5 is perspective view showing a top chassis of a display apparatus according to an exemplary embodiment of the present invention. FIG. 6 is a cross-sectional view taken along a line shown in FIG. 5 according to an exemplary embodiment of the present invention.

Referring to FIGS. 5 and 6, a third part 160 protrudes from the first inner surface 116 of the first part 110 by a third width 160w and is spaced apart from the second part 120. For example, a third inner surface 166 or a third outer surface 168 of the third part 160 is connected to the first inner surface 116 of the first part 110.

A first light sensor 210 is disposed at a first corner of the top chassis TC. The first light sensor 210 is disposed on the first inner surface 116 of the first part 110. According to an embodiment, the first light sensor 210 is disposed adjacent to the inner surface 112. The first light sensor 210 is disposed toward a corner which is positioned diagonally from the first corner. A second light sensor 220 is disposed at a second corner of the top chassis TC, which is adjacent to the first corner. The second light sensor 220 is disposed on the first inner surface 116 and adjacent to the inner surface 112. The second light sensor 220 is disposed toward a corner that is positioned diagonally from the second corner.

According to an embodiment, a third light sensor (not shown) is disposed at a corner of the top chassis TC, which is adjacent to the first light sensor 210 or the second light sensor 220.

The light sensors 210 and 220 are coupled to the top chassis TC by a coupling part, e.g., screws, or attached to the top chassis TC by a double sided tape. The light sensors 210 and 220 detect invisible light, e.g., infrared light. The light sensors 210 and 220 include a charge-coupled device (CCD) or a complementary metal oxide semiconductor (CMOS).

Referring to FIGS. 3 and 6, the reflection part RP is disposed on the third outer surface 138 or 168 of the third part 130 or 160. The reflection part RP is discontinuously arranged similarly to the third part 130 or 160. As a consequence, the reflection part RP is disposed not to disturb the light receiving operation of the light sensors 210 and 220. For example, the reflection part RP is disposed to expose the light sensors 210 and 220. The reflection part RP is not provided between the light sensors 210 and 220 adjacent to each other. The reflection part RP is formed of a material that reflects light from an outside source. For instance, the reflection part RP is a reflective tape that is attached to the third part 130 or 160.

Referring to FIG. 3 again, the reflection part RP is attached on the third outer surface 138, and thus the reflection part RP protrudes further than the inner surface 112 of the first part 110.

Referring to FIG. 6 again, the reflection part RP is attached on the third outer surface 168 of the third part 160 and disposed in a space provided by the third outer surface 168 and the first inner surface 116. The inner surface 112 protrudes further than the reflection part RP as shown in FIG. 6. Alternatively, the reflection part RP is disposed to be coplanar with the inner surface 112 of the first part 110.

FIG. 7 is a cross-sectional view showing a top chassis of a display apparatus according to an exemplary embodiment of the present invention.

Referring to FIGS. 1 and 7, the flexible wire FW connecting the display panel DP with the display driver DPO is bent along an outer portion of the mold frame MF, and the display driver DPO is disposed under the bottom chassis BC. According to an exemplary embodiment, the connection wire CW connecting the light sensors LSS with the light sensing controller LSO is bent along the out portion of the mold frame MF, so that the light sensing controller LSO is disposed under the bottom chassis BC. The display driver DPO and the light sensing controller LSO partially overlap each other or do not overlap each other when viewed in a plan view.

Since the light sensing controller LSO is disposed under the bottom chassis BC, the peripheral area of the display apparatus is reduced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a display panel configured to display an image, the display panel including a front surface;
a top chassis covering an edge portion of the display panel; and
a light sensor on the top chassis.

2. The display apparatus of claim 1, wherein the light sensor is provided in at least two at at least two corners, respectively, of the display panel.

3. The display apparatus of claim 2, wherein the light sensors are disposed at two ends of a side of the display panel.

4. The display apparatus of claim 2, wherein the light sensors are attached to the top chassis.

5. The display apparatus of claim 2, wherein each of the light sensors comprise a light emitting part and a light receiving part.

6. The display apparatus of claim 5, further comprising a reflection part on an inner surface of the top chassis which corresponds to another side of the display panel.

7. The display apparatus of claim 6, wherein the front surface of the display panel comprises a display area displaying the image and a peripheral area surrounding the display area, the top chassis comprises a front portion covering the peripheral area along the edge portion of the display panel and a side portion bending and extending downward from the front portion and covering a side of the display panel, and the light sensors are disposed between the front surface and the front portion.

8. The display apparatus of claim 7, wherein the top chassis further comprises a protrusion portion protruding downward from the front portion, wherein the protrusion portion faces the light sensors, and the reflection part is disposed on the protrusion portion.

9. The display apparatus of claim 8, wherein the reflection part has a tape shape and is attached on the protrusion portion.

10. The display apparatus of claim 1, further comprising a light sensing controller on a circuit board.

11. The display apparatus of claim 10, further comprising a mold frame on which the edge portion of the display panel is mounted, wherein the light sensing controller is disposed at a side of the mold frame to be perpendicular to the front surface of the display panel.

12. The display apparatus of claim 10, further comprising a display driver connected to the display panel and mounted on another circuit board.

13. The display apparatus of claim 12, wherein the light sensing controller and the display driver are disposed on a rear surface of the display panel and partially overlap each other.

14. The display apparatus of claim 12, further comprising a backlight unit between the display panel, and the light sensing controller and the display driver.

15. A display apparatus comprising:
a display panel; and
a top chassis to cover a part of the display panel
wherein the top chassis comprises:
a first part having a rectangular frame shape, wherein the first part includes an inner surface defining an opening area, an outer surface opposite to the inner surface, a first outer surface connecting the inner surface with the outer surface, and a first inner surface opposite to the first outer surface;
a second part connected to the outer surface and extending from the first inner surface;
a third part facing the second part and spaced apart from the second part, wherein the third part extends from the first part;
a reflection part on the third part toward the opening area; and
a light sensor on the first inner surface.

16. The display apparatus of claim 15, further comprising:
a light sensing driver electrically connected to the light sensor; and
a display driver electrically connected to the display panel, wherein the light sensing driver and the display panel driver are disposed on a rear surface of the display panel and overlap each other.

17. The display apparatus of claim 16, further comprising:
a light sensing driver electrically connected to the light sensor; and
a display driver electrically connected to the display panel; and
a backlight unit under the display panel, wherein the light sensing driver and the display driver are disposed on a rear surface of the backlight unit.

18. The display apparatus of claim 16, wherein the third part comprises a first surface facing the second part and a second surface opposite to the first surface, wherein the first surface and the second surface are connected to the first inner surface.

19. The display apparatus of claim 16, wherein the third part comprises a first surface facing the second part and a second surface opposite to the first surface, wherein the first surface and the second surface are connected to the first inner surface and the inner surface, respectively.

20. The display apparatus of claim 16, wherein the second part is connected to the outer surface and perpendicular to the first part, and wherein the third part is discontinuously elongated along the first part.

21. The display apparatus of claim 16, wherein the first part and the third part are integrally formed with each other.

22. A display apparatus comprising:
a display panel;
a chassis over the display panel, the chassis including an opening and an edge portion surrounding the opening, wherein the edge portion covers a non-display area of the display panel; and
two or more light sensors between the edge portion of the display panel and the non-display area of the chassis.
